(19) United States
(12) Patent Application Publication
(10) Pub. No.: US 2004/0097371 A1
(43) Pub. Date: May 20, 2004

(54) Application of conductive adsorbents, activated carbon granules and carbon fibers as substrates in catalysis

(76) Inventor: Juzer Jangbarwala, Chino Hills, CA (US)

Correspondence Address: THOMPSON HINE L.L.P., 2000 COURTHOUSE PLAZA , N.E., 10 WEST SECOND STREET, DAYTON, OH, 45402, US

(21) Appl. No.: 10/658,079

(22) Filed: Sep. 9, 2003

Related U.S. Application Data
(60) Provisional application No. 60/427,524, filed on Nov. 19, 2002.

(51) Int. Cl. B01J 21/18

(52) U.S. Cl. 502/439

(57) ABSTRACT

Disclosed are methods for conducting catalytic reactions where energy is supplied to catalyst molecules locally by using a support having thermal and electrical conductivity wherein catalysts are dispersed therein or disposed thereon and activated through the support.

### CROSS REFERENCE TO RELATED APPLICATIONS

This invention claims priority from U.S. Provisional Application No. 60/427,524 filed on Nov. 19, 2002.

### BACKGROUND OF THE INVENTION

1. Field of the Invention

The present invention relates to a method of improving the catalysis reactions, which are widely used in producing chemical products and in environmental control. In particular, the present invention relates to a method of providing the required energy to catalyst molecules in a very efficient way by using a support, which is thermally and electrically conductive wherein catalysts are dispersed therein or disposed thereon.

2. Description of the Related Art

Numerous industries use catalytic processing techniques either to produce useful materials and compositions or to reduce waste or pollutants. Examples of such industries include those based on electricity generation, turbines, internal combustion engines, environmental and ecological protection, polymer and plastics manufacturing, petrochemical synthesis, specialty chemicals manufacturing, fuel production, batteries, biomedical devices, and pharmaceutical production. These industries are in continuous need of higher efficiency catalysts and catalytic processes that can impact the costs and performance of the products generated by these industries.

Catalysis refers to the acceleration of any physical, chemical or biological reaction by a small quantity of a substance, conventionally known as a catalyst, the amount and nature of which remains essentially unchanged during the reaction. Alternatively, catalysis refers to applications where the catalyst can be regenerated or its nature essentially restored after the reaction by any suitable means such as, but not limited to, heating, pressure, oxidation, reduction, and microbial reaction.

Heterogeneous catalytic reactions are widely used in chemical processes in the petroleum, petrochemical and chemical industries. Such reactions are commonly performed with the reactant(s) and product(s) in the fluid phase and the catalyst in the solid phase. In heterogeneous catalytic reactions, the reaction occurs at the interface between phases, i.e., the interface between the fluid phase of the reactant(s) and products(s) and the solid phase of the supported catalyst. Hence, the properties of the surface of a heterogeneous supported catalyst are significant factors in the effective use of that catalyst. Specifically, the surface area of the active catalyst, as supported, and the accessibility of that surface area to reactant chemisorption and product desorption are important. These factors affect the activity of the catalyst, i.e., the rate of conversion of reactants to products and the purity of products. The chemical purity of the catalyst and the catalyst support have also an important effect on the selectivity of the catalyst, i.e., the degree to which the catalyst produces one product from among several products, and the life of the catalyst.

Generally catalytic activity is proportional to catalyst surface area and high specific area is therefore desirable. However, that surface area must be accessible to reactants and products as well as to heat flow. The chemisorption of a reactant by a catalyst surface is preceded by the diffusion of that reactant through the internal structure of the catalyst and the catalyst support, if any. The catalytic reaction of the reactant to a product is followed by the diffusion of the product away from the catalyst and catalyst support. Heat must be able to flow into and out of the catalyst and its support as well.

Since the active catalyst compounds are often supported on the internal structure of a support, the accessibility of the internal structure of a support material to reactant(s), product(s) and heat flow is important. Porosity and pore size distribution are measures of that accessibility. Various types of supports and support materials are available and utilized in the above processes.

### SUMMARY OF THE INVENTION

While a need exists for improving the efficiency of all aspects of catalytic processing, including devices for performing catalytic processing and methods of making devices for catalytic processing, in the past the improvements, in general, have been directed towards the catalyst itself. It has now been found that by shifting the focus to the support material of the catalyst, improvements in efficiency of catalytic processes can be achieved.

In preferred embodiments, the present invention relates to providing a catalyst on a conductive support, which is able to supply energy in the form of resistive heat to a catalyst when a current is passed through it. Thus, the conductive support provides thermal and electrical energy to locally activate the catalyst. By “locally” is meant that heat is generated at the site of the catalyst where the heat is most useful in promoting the reaction. Catalyst provided on conductive supports and activated in accordance with the preferred embodiments can be extended to a wide variety of industrial applications and can be used to improve the efficiency of existing catalysts. Preferred embodiments of the present invention include:

In a method for conducting a chemical reaction in the presence of a catalyst the improvement comprising providing the catalyst on a support that is thermally and electrically conductive and supplying an electric current to the catalyst on the support such that the temperature of the catalyst increases.

A reactor for performing a chemical reaction comprising a chamber including a pair of electrodes that are spaced apart, a catalyst on a thermally and electrically conductive support provided between the electrodes, and a source of electric current for supplying a current to the electrodes.

A method for supporting a catalyst comprising a catalyst and a support, where the support comprises a conductive support, where the conductive support is thermally and electrically conductive and whereby the support is conductive and where the catalyst is dispersed in or on the conductive support.

A method for supplying energy to a catalyst comprising providing a conductive support and a catalyst dispersed therein or thereon the conductive support, where the support comprises carbon and/or any other suitable thermally and electrically conductive substance, and providing energy to the conductive support whereby the energy activates the conductive support thereby providing the catalyst with energy at the local level, where the energy provided at the local level is sufficient to activate the catalyst.

Use of a thermally and electrically conductive support for supporting catalysts.

### BRIEF DESCRIPTION OF THE DRAWINGS

FIG. 1 is a schematic view of a reactor in accordance with one embodiment of the present invention.

### DETAILED DESCRIPTION OF THE PREFERRED EMBODIMENT

The improvements discussed herein involve improving the efficiency of catalytic processing including devices for performing catalytic processing and methods of making devices for catalytic processing. The present invention is described herein in terms of several specific examples but it is readily appreciated that the example and disclosed embodiment can be modified in a predictable manner to meet the needs of a variety of particular applications. Except as otherwise noted herein, the specific examples shown herein are not limitations on the basic teachings of the present invention but are instead merely illustrative examples that aid understanding. The catalytic techniques used in this invention can be used in conjunction with various chemical reactions including steam reformation, oxidation and cracking reactions.

The supported catalysts according to preferred embodiments can be applied to various catalytic reactions in various areas, which include, but are not limited to, oxidation of volatile organics and perfluorocarbons from semiconductor manufacturing, groundwater remediation, NOx abatement from burners, water-gas shift reactions, polymer production, hydrocracking reactions, hydrogen gas production from gaseous hydrocarbons such as the reformation process involving methanol or methane. For example, the configurations of the embodiments discussed above and illustrated in the figures can effectively be used in environmental remediation, refining, plastics manufacturing, organic chemical manufacturing, fuel cells, and specialty gas sensing devices, to name a few.

### Reactor

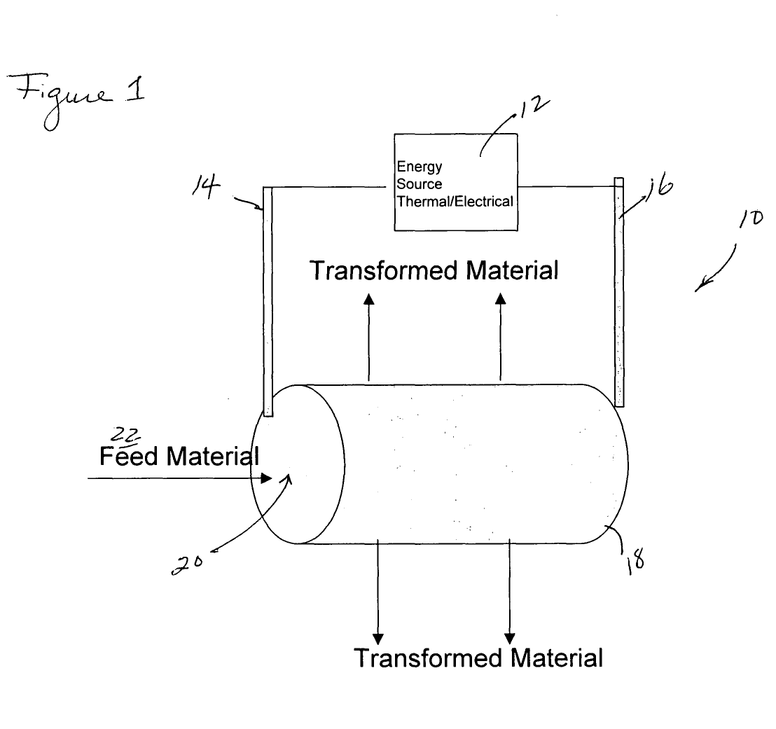

FIG. 1 is a schematic illustration of a reactor in accordance with one embodiment of the present invention. The reactor 10 includes a power source 12 that is electrically connected to a pair of electrodes 14, 16. The electrodes are connected to a conductive support 18 such as a carbon cloth on which the catalyst and optionally a carrier is deposited and/or embedded as described below in detail. In this particular embodiment, the cloth is wound into a roll and reactants in the form of a fuel material 22 are fed to the center 20 of the roll. The cloth is sufficiently permeable that the reactants permeate through the roll. As they do a current is passed through the roll by means of the electrodes. This causes the roll to heat and in turn to transfer that heat to the catalyst that is deposited or contained therein or thereon. In this process the reaction product is formed. Optionally, the reactor may additionally include an external heat source such as a furnace or a burner.

### Catalyst and Carrier

Methods of making catalysts most commonly involve depositing the catalyst on a support and/or carrier. A wide range of supports and carriers are known and available in the art that can be used in the present invention. In accordance with the preferred embodiments, the support materials when conducting an electric current heat up and provide the necessary energy to activate the catalyst materials for catalysis reactions.

Solid based catalysts include metals, metal oxides or a combination of both, dispersed in a mixture (solid or liquid) with a high surface area inorganic carrier. This carrier becomes part of the composition of the catalyst. This catalytic mixture is then deposited onto the support.

Dispersing catalysts over the porous network can be accomplished by ion exchange (e.g., using a cation salt containing catalytic species which can exchange with the surface carrier cation such as the method described in U.S. Pat. No. 6,383,972), constant current, reverse pulse DC current electrochemical deposition, electroless chemical deposition, or simple impregnation (such as the methods described in U.S. Pat. Nos. 6,413,898 and 6,383,972). Any suitable methods known and available in the art can be employed to produce a complex of catalytic species supported on a carrier.

In the preferred embodiments, any suitable catalytic species can be used, including, but not limited to, metals or metal oxides such as Pt, Pd, Ru, Ni, In, P, TiO₂, V₂O₅, MoO₂, WO₃, ZnO, SnO₂, CuO, Cu₂O, FeO, Fe₂O₃, etc. Such catalytic species are known and have been described in the art, for example in U.S. Pat. Nos. RE 34,853, 6,413,898, 6,383,972, 6,159,533, 6,362,128, and 6,361,861. Catalytic activity generally increases with surface area and hence smaller particle size. Typically, the catalyst mixture will have a particle size of about 0.05 to 45 micrometers.

In accordance with the preferred embodiments, catalytic species are those used for reactions that require that the catalytic species be heated for the reaction to occur effectively. In some cases, heat is generated by the reaction itself. In that case, the catalytic species need not be heated by the inherent resistance of the conductive support for the entire thermal requirement of the catalytic reaction.

Any of the above metals or metals oxides can be mixed (dry or in suspension) with carriers such as graphite powder, graphite or activated carbon powder, Al₂O₃, SiO₂, TiO₂, MgO, ZrO₂ and mixtures thereof. Any suitable carrier can be used in the mixture. Preferably, a carrier is a high surface area inorganic material containing a complex pore structure into which catalytic species can be deposited while in mixture or suspension with it. The porous structure is important in maintaining catalytic activity, selectivity, and durability. For example, a particle of a preferred carrier before being sintered will desirably have pores from about 1 to about 100 Å in diameter and a surface area of about 1 to about 1000 m²/g. The carrier can make up about 10 to 95% of the catalyst/carrier mixture. The amount of the carrier used will vary depending on the catalyst and the reaction.

The types of catalyst and carrier can be selected depending on the intended use of the catalyst. Regarding the types of catalytic species and carriers and methods of formation of a catalyst, the following are herein incorporated by reference. An example of a catalyst (CuO—ZnO/Al₃_{O}₂) deposited by chemical precipitation is discussed by Velu et al. (Chem. Commun. 1999. p. 2341-2342), Amphlett et all, (Proceedings of 7^{th} Canadian Hydrogen Workshop, June 1995). An example of a catalyst (Cu/ZnO) prepared by microemulsion technique is discussed by Agrell et al. (Applied Catalysis A: General. 2001. 211:2, pages 239-250) and an example of a catalyst (CuZnO) prepared by conventional co-precipitation as 3 mm pellets, sieves, etc. is discussed by de Wild et al. (Catalysis Today. 2000. 60:1-2, pages 3-10).

The catalysts can be used not only as chemical reaction inducers or promoters, such as exhaust gas cleaning agents, but also as sensors and detectors when the change in the resistance of the catalyst is monitored.

### Support

The catalyst (a combination of catalytic species and a carrier) is then deposited on a support so that it can be practically used. The support functions in a conventional manner to support the catalyst and allows gas or other fluid to efficiently pass through the support, thereby exposing the gas or fluid components of the reaction to a high surface area rich in catalyst composition.

Specific examples in this specification involve application of sub-micron support materials (e.g., 0.01 to 1 micron and often 0.05 to 0.15 micron) that are used as supports for catalysts. Preferably the support is a material that is conductive and has a minimal/small thermal mass. Heavier and denser catalysts, carriers and supports have greater thermal mass (require more calories to generate a one degree increase in temperature) than lighter materials like carbon. It has been found that catalytic performance is significantly enhanced by procedures and structures that reduce the thermal mass of the system while increasing surface area of the catalyst.

Preferred supports can be prepared from various porous materials. The support is thermally and electrically conductive, so that it is possible to very efficiently heat the catalyst to a temperature effective to activate the catalyst materials. The preferred support should have good mechanical strength while retaining the porosity and high surface area for efficient catalysis.

Support materials suitable for use in preferred embodiments, include but are not limited to, heat and electrically conductive carbonaceous materials such as graphite, carbon nanotubes, carbon fibers, activated carbon granules, carbonaceous adsorbents such as Rohm & Haas Ambersorb® (e.g. 572), and ion exchange resins. Use of Ambersorb® resins (e.g. Amber Hi-Lites, 127, 128) for low temperature (catalytic) deep oxidation reactions is described in literature by the Rohm & Haas Company for the Ambersorb® brand carbonaceous adsorbents. Other sources of ion exchange materials suitable as a support material are those of Reilly Industries (e.g. Reillex™ brand Polyvinylpyridine derivative polymers) which are described in the product literature for the Reillex™ polymer. This literature is herein incorporated by reference. Use of carbonaceous adsorbents in automobiles has been discussed in “Automotive Exhaust Hydrocarbon Adsorbtion” by Melvin N. Ingalls (prepared for Rohm & Haas Company, 1993). Use of carbon nanotubes are described in U.S. Pat. No. 6,361,861, and these materials can be used in the present invention as support. The disclosure of the patent is herein incorporated by reference. The carbon fabric described in U.S. Pat. No. 6,383,972 having a pore size of about 0.3 to 3 nm and filaments having a diameter of about 5 to 20 μ and a porosity of about 20 to 50% by volume, is also useful herein. In addition to ion-exchange resins, polymeric adsorbents such as Rohm & Haas: XAD series adsorbents, Dow Chemical, Optipure adsorbents, Purolite: Macronet Polymers are also useful herein. These resins are available as polymer beads and contain high amounts of water (e.g., 40-45% by volume). The ionic impurities present in the water make the beads conductive.

Further, depending on the geometrical shape of the support and its power requirement to provide sufficient heat energy, any other partially conductive materials with electrical resistances in the range of about 1 to 500 ohm/square and more particularly about 5 to about 100 ohm/square can be used. These materials can be mixed with the graphite, carbon nanotubes, activated carbon granules, and carbonaceous adsorbents as described above in amounts of about 1 to 10% of weight. Preferably, these materials are reduced metal oxides such as, but not limited to, TiO₂, ZrO₂, SiO₂, MgO, Al₂O₃, ZnO, etc. More particularly it is possible to enhance the efficiency of the conductive graphite, carbon nanotubes, activated carbon granules, and carbonaceous adsorbents supports by doping the supports with particles of metal oxides in a more oxygen reduced state, (such as CuO to Cu₂O or ZnO to ZnO_{1-m, m<1}, etc.), thereby increasing their electropositivity when exposed to thermal or electrical energies. Some preferred support materials can be prepared by in situ oxidation of nitrate salts of transition metals to precipitate the oxides within, for example, micropores of a resin bead, a carbon fiber or nanotube. This results in electrically conductive materials with a high surface area. Use of graphite or fibrillated carbon as electrodes are described in U.S. Pat. No. 4,046,663 (herein incorporated by reference), and these materials can be used as a support in some embodiments of the invention. An example of a carbon fiber is the GRAFIL™ brand carbon fibers manufactured by Courtaulds, Ltd., Carbon Fibers Unit (Coventry, United Kingdom).

In general, conductive carbonaceous materials may have a porosity of about 0.005 micrometers to about 0.2 micrometers, a heat conductivity of about 0.8 watt/Cm-K to about 23 watt/Cm-K, an electric resistance of about 1 to about 100 ohm/square, and a dielectric constant of about 5 to about 6 at about 10³/Hz.

The concentration of a catalyst (a composition of catalytic species and a carrier) deposited on a support in accordance with one embodiment is preferably in the range of about 10 to 500 μg per cm² (for thin films) or about 1 to 5 grams per cm³ (for dip-coated supports). The preferred concentration depends at least in part on the support materials. The upper limit of the concentration of catalyst deposited on support varies due to porosity and physical dimensions of the support materials.

The supports can be used in a granular media in columnar form or in a configuration such as a cylindrical support to fit in a canister. Columnar forms allow sufficient contact time to perform effective catalysis and allow easy installation. In addition, columnar forms enable the ability to retrofit current industrial installations with ease.

Any suitable methods known and available in the art can be employed to deposit a catalyst on a support. For example, depositing catalysts onto a support can be accomplished via nanoparticulate deposition technologies such as those disclosed in U.S. Pat. No. 6,080,504 and via electroless plating deposition technologies (followed by curing) such as those disclosed in U.S. Pat. No. 4,046,663, the disclosure of which is herein incorporated by reference in its entirety.

### Catalyst Activation

Conventionally, to activate the catalyst, the catalyst deposited on a support is preferably placed in a reactor equipped with a furnace heater, by which the reactor is heated externally. Alternatively, a fluid or gas itself is heated prior to passing through the catalyst. In other cases, a separate heater is used to heat the support. Alternate catalyst activation mechanisms, such as by electricity, have been reported in the literature. However, such processes focus on the catalyst composition itself. For example, in U.S. Pat. No. 6,267,864, the success of the process requires the catalyst itself to be electrically conductive, with the support being non-conductive.

In the preferred embodiments described herein, however, energy necessary for catalysis is applied via a support, not to a catalyst. By using a thermally and electrically conductive support, it is possible to effectively provide energy necessary for catalysis to the catalyst by the support. Thus, the support generates heat and activates the catalyst by using thermal energy provided by the support. By directing the heat through the support instead of heating the catalyst externally (e.g., using a furnace), side reactions can be reduced and less energy is consumed.

Depending on the type of materials of the conductive support, the reaction desired and the amount of energy needed to be transferred to activate the materials, the resistance of the conductive support may vary by about 2 to 3 orders of magnitude. As previously disclosed, the resistance of the support may range from about 1 to 500 ohm/square.

For purposes of summarizing the invention and the advantages achieved over the prior art, certain objects and advantages of the invention have been described above. Of course, it is to be understood that not necessarily all such objects or advantages may be achieved in accordance with any particular embodiment of the invention. Thus, for example, those skilled in the art will recognize that the invention may be embodied or carried out in a manner that achieves or optimizes one advantage or group of advantages as taught herein without necessarily achieving other objects or advantages as may be taught or suggested herein.

The above features of this invention will now be described with reference to the drawings which include preferred embodiments and are intended to illustrate and not to limit the invention.

FIG. 1 is a schematic illustration of an embodiment of the present invention where heat generation from the support using electricity is the source of energy transfer to the catalyst. That is, electrical energy is applied to the conductive support and the energy generated from the conductive support supplies the needed energy to activate the catalyst materials. Thus, the catalyst itself need not be conductive. (In conventional catalysis, in general, radiation or conductive heat from a furnace generate the energy required for the catalyst). In one embodiment, the catalyst is deposited on a carbon cloth. Electrodes can be attached to this cloth by applying Ag paste to the two end-edges and currying at 500° C. for 5 hours to make it conductive.

In another embodiment, the catalyst is deposited on a support bead in the form of a carbon particle or a polymeric bead and the beads are used in the form of a bed through which the reactants can percolate. In this case, the bed is sandwiched between parallel conductive plates. Thermal or electrical energy is applied to the outside of the plates. The water content of the beads conducts the energy to the micropores where the catalyst is embedded. The conductive side plates are connected to the energy source.

In another embodiment, the bead is dispersed in a liquid. However, the beads are connected by a conductive wire, such as copper wire. The wire is then connected to an electrical source. In this case the energy is transferred via the conductive wire to the catalyst location. The reactants can be liquid or gases. If gases, they would be diffused through diffuser tubes into the liquid.

In the embodiment illustrated in FIG. 4, it is possible to conduct the activation of a catalyst laden media column by use of microwave energy. The column may be subjected to low levels of microwaves, supplying adequate energy to heat the water in the beads sufficiently for the local activation of the catalyst by the conductive support.

### REFERENCE EXAMPLE

Table I presents the conversion results for (Sud-Chemie H18-AMT) catalyst, loaded on small carbon fiber plug substrates of 3 mm OD and 1 cm long. 33 such plugs were filled in the working space of a quartz U-tube reactor of 4 mm ID, 12 cm long. The reactor with catalyst/carbon fiber substrate was inserted into a cylindrical shape furnace. A thermocouple was placed inside the reactor indicating the catalyst's temperature. Depending on the steam/carbon (S/C) ratio selected, the HPLC pump fed a mixture of methanol and water to a vaporizer at above 120° C. (methanol vapour pressure is 67° C. and water 100° C.). For example, when S/C=1 was desired, the volume of vapor for both methanol and water was 35.6 standard cubic centimeter (sccm). This corresponds to 0.072 ml/min for methanol and 0.032 ml/min for steam, giving the total flow of HPLC pump at 0.104 ml/min mixture, entering the reactor as feed. The products, both gases and liquids were chilled at the exit of the reactor. The liquid was collected in the chiller and gases sent to the mass spectrometer's chamber for analysis. On a Dry basis (liquid collected) and at a selected furnace temperature the calculated yield (%) of products and the conversion rate are presented in the table. For example at S/C=1 and a furnace temperature of 250° C. (52 watt power input), the conversion is 99.2%, producing 63.6% of the effluent gases as hydrogen. As the furnace power is reduced the temperature is lowered and the conversion rate drops accordingly. The carbon monoxide level is noted to be relatively high at 0.6% or 6000 ppm.

TABLE I
Carbon fiber support (plugs) in a U-tube Reactor
Furnace

| | MeOH | Steam | MeOH | Steam | Flow | T | P | CONV | H2 | CO2 | CO |
|---|---|---|---|---|---|---|---|---|---|---|---|
| S/C | sccm | sccm | ml/min | ml/min | ml/min | ° C. | watt | % | % | % | % |
| 1 | 35.6 | 35.6 | 0.072 | 0.032 | 0.104 | 150 | 21 | 3.1 | 20 | 6.5 | 0.6 |
| | | | | | | 200 | 33 | 5.8 | 31.5 | 9.54 | 0.6 |
| | | | | | | 225 | 41 | 63.9 | 61.3 | 21.2 | 0.2 |
| | | | | | | 250 | 52 | 99.2 | 63.6 | 23.4 | 0.2 |
| 4 | 15.82 | 63.3 | 0.029 | 0.051 | 0.08 | 175 | 25 | 13.9 | 28.3 | 11.5 | 0.17 |
| | | | | | 0.08 | 202 | 33 | 34.1 | 42.7 | 18 | 0.07 |
| | | | | | 0.08 | 221 | 40 | 54.2 | 49 | 21.3 | 0.01 |
| | | | | | 0.08 | 245 | 51 | 97.8 | 56.1 | 24.6 | 0.01 |
| 6 | 11.3 | 67.8 | 0.02 | 0.055 | 0.075 | 245 | 51 | 84.5 | 52.1 | 22.8 | 0.01 |
| | | | | | 0.075 | 255 | 53 | 99.8 | 53.8 | 24.3 | 0.01 |

### EXAMPLE 1

In the one embodiment, a CuO—ZnO/Al₃O₂ catalyst deposited on the (carbon fiber) conductive support was produced by chemical precipitation according to the method of Velu et al. (Velu et. al, Journal of Chemical Communications. (1999) vol. 11, p. 2341-2342). A composition of CuZnAl with atomic ratios corresponding to 137/1.80/1.00 respectively was synthesized using a chemical precipitation with nitrate based salts. The nitrate salts of the Cu, Zn and Al were dissolved in de-ionized water and the pH was adjusted drop-wise while stirring to about 9-10 with ammonium hydroxide. The formed hydrogel was precipitated, then filtered using a glass Büchner funnel with de-ionized water, then ethanol. The collected gel was dried at 100-120° C. and the dried powder was ground using a mortar and pestle. The powder was calcined at a rate of 5-10° C. per minute up to 550° C., and allowed to dwell at that temperature for about 2 hours. Commercially available carbon fibers were used, such as those manufactured and provided by Courtalds, Ltd., Coventry, UK. The carbon fiber cloth was cut to 2″×0.75″×0.5″ in dimensions. Silver electrodes were applied to the two edges and the cloth was dip-coated in the propanol suspension several times and air dried. The catalyst loading was ˜4 g in weight after 5 dip coatings. It was then transferred into a reactor and reduced under 12% CO gas (balance Ar gas) at 265° C. for 2 hours to de-gas and condition the freshly loaded catalyst. The catalyst was used in a methanol steam reforming reaction according to the equation:

CH₃OH+H₂O÷3H₂+CO₂

### EXAMPLE 2

In a second preparation a similar support coating was performed with a commercial (Sud-Chemie-H18-AMT; 50 m²/g) catalyst powder composition of 55% Cu, 35% Zn and 10% Al. This catalyst has an 8-10 times higher surface area (m²/g) than the catalyst from Example 1. This catalyst was used in a methanol reforming process. Depending on the steam-to-carbon ratio (S/C) a mixture of methanol and water was fed into a vaporizer kept at >120° C., vaporizing both methanol and water. A 10 sccm argon carrier gas was used to carry the vaporized mixture into a reactor over the catalyst and the by-products Effluent was first fed through a chiller to separate any condensed steam and/or other liquid and gas. The gas was then analyzed by a Mass spectrometer and exhausted to a fume hood.

Electrodes were attached to the catalyst coated carbon cloth and the cloth was placed in a reactor that was equipped with a small heating element so that the catalyst could be used in two modes. Individual DC power supplies were provided to heat the heating element and the catalyst support electrodes independently. In one mode the catalyst was externally heated by the heating element and the temperature of the catalyst monitored at 200-250° C. as reported in Table II below. In the second mode the catalyst was heated by passing a constant electric current through the cloth. The temperature of the catalyst was monitored and is also reported in Table II. The results in Table II when compared to the results in Table I for the Reference Example show that equivalent conversion can be achieved using the catalyst in its activated mode as compared to the external heating mode. Equivalent conversion is achieved at lower power, lower temperature and lower carbon monoxide production.

TABLE II
Carbon fiber support (2″ × ¾″ × ½″) in a cylindrical reactor

| | | | | | | | | | | | |
|---|---|---|---|---|---|---|---|---|---|---|---|
| | MeOH | Steam | MeOH | Steam | Flow | T | P | CONV | H2 | CO2 | CO |
| S/C | sccm | sccm | ml/min | ml/min | ml/min | ° C. | watt | % | % | % | % |

Furnace

| | | | | | | | | | | | |
|---|---|---|---|---|---|---|---|---|---|---|---|
| 1 | 35.6 | 35.6 | 0.072 | 0.032 | 0.104 | 250 | 18 | 99.2 | 59.8 | 24.1 | 1 |
| | | | | | | 230 | 15 | 97.8 | 60.6 | 24.1 | 0.82 |
| | | | | | | 208 | 11 | 75.5 | 59.2 | 24.2 | 0.24 |

Activated Support

| | | | | | | | | | | | |
|---|---|---|---|---|---|---|---|---|---|---|---|
| 1 | 35.6 | 35.6 | 0.072 | 0.032 | 0.104 | 136 | 9.5 | 99.2 | 60 | 23.8 | 1.2 |
| | | | | | | 127 | 8.5 | 95 | 59.5 | 24.9 | 0.48 |
| | | | | | | 86 | 6.8 | 76.3 | 58.8 | 24.5 | 0.24 |
| 4 | 15.82 | 63.3 | 0.029 | 0.051 | 0.08 | 122 | 8.1 | 99.8 | 45.5 | 19.2 | 0.16 |
| | | | | | | 118 | 7.5 | 99.8 | 53.8 | 24.1 | 0.12 |
| | | | | | | 114 | 6.8 | 91.6 | 44.6 | 18.1 | 0.12 |
| 6 | 11.3 | 67.8 | 0.02 | 0.055 | 0.075 | 122 | 8.1 | 99.9 | 55.6 | 23.5 | 0.01 |
| | | | | | | 114 | 6.8 | 98.3 | 53.9 | 23.4 | 0.01 |
| | | | | | | 101 | 4.9 | 73.1 | 49.8 | 21.9 | 0.01 |

The Examples described above are set forth assist in the understanding of the invention. Thus, those skilled in the art will appreciate that the methods of the present invention can provide the require activation energy for any catalytic reaction for which the catalyst requires activation energy, whether gas or liquid phase, etc.

One skilled in the art would readily appreciate that the preferred embodiments described above are well adapted to carry out the objects and obtain the ends and advantages mentioned, as well as those inherent therein. The methods and procedures described herein are presently representative of preferred embodiments and exemplary and are not intended as limitations on the scope of the invention. Changes therein and other uses will occur to those skilled in the art which are encompassed within the spirit of the invention. Thus, it should be understood that although the present invention has been specifically disclosed by preferred embodiments and optional features, modification and variation of the concepts herein disclosed may be resorted to by those skilled in the art, and that such modifications and variations are considered to be falling within the scope of the invention.

Having described the invention in detail and by reference to specific embodiments thereof, it will be apparent the numerous modifications and variations are possible without departing from the spirit and scope of the invention.

What is claimed is:

1. In a method for conducting a chemical reaction in the presence of a catalyst the improvement comprising:
providing the catalyst on a support that is thermally and electrically conductive and
supplying an electric current to the catalyst on the support such that the temperature of the catalyst increases.

2. The method of claim 1 wherein the support is selected from the group consisting of conductive graphite, carbon nanotubes, activated carbon granules, and carbonaceous adsorbents

3. The method of claim 2 wherein the support is doped with a metal oxide.

4. The support of claim 3 wherein the support is carbon fiber.

5. The method of claim 1 wherein the catalyst is selected from the group consisting of as Pt, Pd, Ru, Ni, In, P, TiO₂, V₂O₅, MoO₂, WO₃, ZnO, SnO₂, CuO, Cu₂O, FeO, Fe₂O₃

6. The method of claim 5 wherein the catalyst is present in admixture with a carrier.

7. The method of claim 6 wherein the carrier is selected from the group consisting of graphite powder, graphite or activated carbon powder, Al₂O₃, SiO₂, TiO₂, MgO, ZrO₂and mixtures thereof.

8. The method of claim 6 wherein the carrier is sintered and has pores from about 1 to about 100 Angstrom in diameter.

9. The method of claim 8 wherein the carrier has a surface area of about 1 to 1,000 mm²g.

10. The method of claim 1 wherein the catalyst on the support is in the form of a particle and the chemical reaction is conducted in the presence of a bed of contacting particles.

11. The method of claim 10 wherein the bed of particles is captured between a pair of electrodes.

12. The method of claim 1 wherein the support is a conductive carbonaceous material having a porosity of about 0.005 to about 0.2 micrometers.

13. The method of claim 12 wherein the support possesses a heat conductivity of about 0.8 watt/cm-K to about 23 watt/cm-K.

14. The method of claim 13 wherein the support exhibits an electrical resistance of about 1 to about 100 ohm/square.

15. The support of claim 14 wherein the support exhibits a dielectric constant of about 5 to 6 at about 10³/hz.

16. The method of claim 1 wherein the catalyst is present on the support in an amount of about one microgram to 10 grams/cm².

17. The method of claim 1 wherein the support is a woven or non-woven carbon fiber cloth or felt.

18. The method of claim 17 wherein the carbon fiber cloth or felt is folded or rolled and the reaction is carried out by passing chemical reactants between the folds or rolls in the cloth/felt.

19. The method of claim 1 wherein the support is a polymeric adsorbent.

20. The method of claim 19 wherein the polymeric adsorbent is an ion exchange resin.

21. The method of claim 20 wherein the resin is a bead.

22. The method of claim 1 wherein the catalyst contains copper, zinc and aluminum.

23. The method of claim 1 wherein the electric current that is passed through the catalyst increases the temperature of the catalyst about 50 to 1200 degrees C.

24. The method of claim 1 wherein the chemical reaction is a methanol steam reforming reaction.

25. The method of claim 1 wherein the support is a non-woven carbon fiber plug.

26. The method of claim 1 wherein a plurality of contacting non-woven carbon fiber plugs carrying the catalyst are interposed between a pair of electrodes.

27. A reactor for performing a chemical reaction comprising a chamber including a pair of electrodes that are spaced apart, a catalyst on a thermally and electrically conductive support provided between the electrodes, and a source of electric current for supplying a current to the electrodes.

28. The reactor of claim 27 wherein the reactor includes an inlet and an outlet and chemical reactants are supplied to the reactor through the inlet and reaction products are removed from the reactor through the outlet.

29. A method for supporting a catalyst comprising:
providing a conductive support, wherein the conductive support is thermally and electrically conductive;
providing a support, wherein said support comprises the conductive support, thereby forming a conductive support;
providing a catalyst; and
dispersing said catalyst in or on the conductive support, thereby supporting said catalyst.

30. A method for supplying energy to a catalyst comprising:
providing a conductive support, wherein the conductive support carbon and/or any suitable thermally and electrically conductive substance, and wherein the conductive support is thermally and electrically conductive;
providing a support, wherein said support comprises the conductive support, thereby forming a conductive support;
providing a catalyst; and
dispersing said catalyst in or on the conductive support; and
providing energy to said conductive support, whereby said energy activates said conductive support thereby providing said catalyst with energy at the local level, wherein said energy provided at local level is sufficient to activate said catalyst.

31. In a method for conducting a chemical reaction in the presence of a catalyst, the improvement comprising:
providing the catalyst on a support that heats when placed in a microwave field, and
exposing the support to a microwave field to cause the temperature of the catalyst to increase.
